(19) United States
(12) Patent Application Publication
(10) Pub. No.: US 2006/0017041 A1
(43) Pub. Date: Jan. 26, 2006

(54) Nitride phosphors and devices

(75) Inventors: Yongchi Tian, Princeton Junction, NJ (US); Perry Niel Yocom, Washington Crossing, PA (US)

Correspondence Address: SARNOFF/JACKSON, PATENT DEPARTMENT, SARNOFF CORPORATION, 201 WASHINGTON ROAD CN 5300, PRINCETON, NJ, 08543-5300, US

(73) Assignee: Sarnoff Corporation, Princeton, NJ (US)

(21) Appl. No.: 11/165,971

(22) Filed: Jun. 24, 2005

Related U.S. Application Data
(60) Provisional application No. 60/583,404, filed on Jun. 25, 2004.
(60) Provisional application No. 60/582,957, filed on Jun. 25, 2004.
(60) Provisional application No. 60/587,203, filed on Jul. 12, 2004.
(60) Provisional application No. 60/609,209, filed on Sep. 10, 2004.
(60) Provisional application No. 60/624,300, filed on Nov. 2, 2004.

(51) Int. Cl. C09K 11/77; C09K 11/08; C09K 11/54

(52) U.S. Cl. 252/301.4 F; 252/301.4 R; 252/301.4 H; 252/301.6 R; 252/301.6 F

(57) ABSTRACT

Provided, among other things, is a phosphor according to the formula: A. a phosphor according to the following formula
M_{f}SiₐAl_{b}B_{c}N_{d}O_{g}:Rε,Z (A); or B. a phosphor according to the following formula
Msn:Rγ,Z² (B) wherein Msn is a silicon nitride or silicon nitride-oxide of one of:
(Mₓ¹M₁₋ₓ²)(Si₅N₈):Rγ,Z² (i)
Lsno:Rγ,Z² (ii)
Ln₂Si_{3-z}Al_{z}O_{3+z}N_{4-z}:Rγ,Z² (iii) Lsno is a lanthanide silicon nitride-oxide of one of:
Ln(SiO₄)N₃:Rγ,Z² (iia)
LnSi₂O₇N₂:Rγ,Z² (iib)
LnSiO₂N:Rγ,Z² (iic)
Ln₂SiO₃N₄:Rγ,Z² (iid)
Ln₂Si₈O₄N₁₁:Rγ,Z² (iie); or
Mₙ³Si_{3-y}BO_{3+y}N_{4-y}:Rδ,Z³ (C); or
M_{f1}⁴Siₐ₁Al_{b1}B_{c1}N_{d1-e1-g1}O_{g1}Dₑ₁:RφZ⁴ (D)
wherein D is P, Bi, Sb, As or a mixture thereof, and Rε, Rγ, Rδ and Rφ are activators, and M, M¹, M², M³ and M⁴ are cations.

When filed under 35 U.S.C. §111(a), this application will claim the priority of U.S. Provisional Application 60/583,404, filed 25 Jun. 2004 (SAR 15119), U.S. Provisional Application 60/582,957, filed 25 Jun. 2004 (SAR 15120), U.S. Provisional Application 60/587,203, filed 12 Jul. 2004 (SAR 15130P), and U.S. Provisional Application 60/609,209, filed 10 Sep. 2004 (SAR 15130PA), and U.S. Provisional Application 60/624,300, filed 2 Nov. 2004 (SAR 15130PB).

The present invention relates to certain nitride phosphors, methods of making, and LED-based lighting devices modified with the phosphors. The present invention further relates to certain visible light emitting phosphors useful for light emitting diode lighting applications.

In lighting applications phosphors can be used to modify the wavelength of the light output. For example, with UV or blue light emitting diodes can be enhanced to produce visible light or less blue light by positioning phosphors along the emission pathway to convert light to longer wavelengths. Blue, green and red emitting phosphors can be used to modify UV to white light. Green and red emitting phosphors can be used to modify a blue output to white light. Yellow emitting phosphors can be mixed with light from a blue emitting diode or a blue emitting phosphor to create light of white chromaticity. Light from other UV or blue emitting devices, such as fluorescent lamps, can be similarly modified. The phosphor described here, when matched with appropriate other light sources, can be used in such applications.

### SUMMARY OF THE INVENTION

Provided, among other things is a phosphor according to one of A, B, C or D, below:

A. a phosphor according to the following formula
M_{f}SiₐAl_{b}B_{c}N_{d}O_{g}:Rε,Z (A)
wherein M is one or more of (i) the following divalent cations: Ba, Sr, Ca, Zn, Mg and (ii) 1:1 mixtures of (1) monovalent Li, Na or K and (2) trivalent Y, Gd or La; Rε is Eu²⁺, Ce³⁺, Yb²⁺, Sm³⁺, Pr³⁺, or a mixture thereof; Rε is present in an amount to provide luminescent emission; f, a, b, c, d, and g are selected to provide a charge neutral solid solution or compound; f, a, b, and g are >0; c and d are >0; and Z is an optional halide or halides selected from Cl⁻, F⁻, Br⁻ or I⁻; or

B. a phosphor according to the following formula
Msn:Rγ,Z² (B)
wherein Rγ is Eu²⁺, Ce³⁺, Yb²⁺, Sm³⁺, Pr³⁺, or a mixture thereof, Rγ is present in an amount to provide luminescent emission, Z² is a halide or mixture of halides selected from Cl⁻, F⁻, Br⁻ or I^{-, Z}² is present in an amount from 0.1 mole % to 20 mole % (of Msn), and Msn is a silicon nitride or silicon nitride-oxide of one of:
   (Mₓ¹M₁₋ₓ²)(Si₅N₈):Rγ,Z² (i)
   Lsno:Rγ,Z² (ii)
   Ln₂Si_{3-z}Al_{z}O_{3+z}N_{4-z}:Rγ,Z² (iii)
wherein M¹ and M² are independently selected from Mg²⁺, Ca²⁺, Sr²⁺and Ba²⁺, x is a value from 0.5 to 1, z is a value from 0 to 2, Lsno is a lanthanide silicon nitride-oxide of one of:
   Ln(SiO₄)N₃:Rγ,Z² (iia)
   LnSi₂O₇N₂:Rγ,Z² (iib)
   LnSiO₂N:Rγ,Z² (iic)
   Ln₂SiO₃N₄:Rγ,Z² (iid)
   Ln₂Si₈O₄N₁₁:Rγ,Z² (iie)
wherein Ln is a trivalent lanthanide or mixture of trivalent lanthanides; or

C. a phosphor according to the following formula
Mₙ³Si_{3-y}BO_{3+y}N_{4-y}:Rδ,Z³ (C)
wherein Rδ is Eu²⁺, Sm²⁺, Yb²⁺, Ce³⁺, Pr³⁺, or a mixture thereof, Rδ is present in an amount to provide luminescent emission, Z³ is a halide or mixture of halides selected from Cl⁻, F⁻, Br⁻or I⁻, Z³ is present in an amount from 0 to 40 mole %, M³ is (i) a trivalent lanthanide which is La, Ce, Pr, Nd, Sm, Eu, Gd, Tb, Dy, Ho, Er, Tm, Yb, or a mixture thereof or (ii) a divalent alkaline earth cation or mixture thereof, and n is the summed formula contributions of the metal(s) of M³, with the value appropriate in light of the valence of the component cations to balance formula (I), and y is a value from 0 to 1; or

D. a phosphor according to the following formula
M_{f1}⁴Siₐ₁Al_{b1}B_{c1}N_{d1-e1-g1}O_{g1}Dₑ₁:Rφ,Z⁴ (D)
wherein M⁴ is one or more of (i) the following divalent cations: Ba, Sr, Ca, Zn, Mg and (ii) 1:1 mixtures of (1) monovalent Li, Na or K and (2) trivalent Y, Gd or La; Rφ is Eu²⁺, Ce³⁺, Yb²⁺, or ions of Pr, Nd, Sm, Gd, Tb, Dy, Ho, Er or Tm, or a mixture of the foregoing choices for Rφ; Rφ is present in an amount to provide luminescent emission; D is P, Bi, Sb, As or a mixture thereof, in atomic or ionic form; f1, a1, b1, c1, d1, e1and g1are selected to provide a charge neutral solid solution or compound; a1 and b1 are ≧0; f1, c1, d1, e1and g1 are >0; and Z⁴ is a halide or mixture of halides selected from Cl⁻, F⁻, Br⁻ or I⁻, which is optionally present.

### EXEMPLARY EMBODIMENTS

A family of activated nitride phosphors are believed to be useful for such applications. These phosphors are indicated by the diagram in FIG. 1. In FIG. 1, the subscripts are selected to provide a charge neutral solid solution or compound.

Group A

In one embodiment, the phosphors of the invention are according to the formula:
M_{f}SiₐAl_{b}B_{c}N_{d}O_{g}:Rε (A)
wherein M is one or more of (i) the following divalent cations: Ba, Sr, Ca, Zn, Mg and (ii) 1:1 mixtures of (1) monovalent Li, Na or K and (2) trivalent Y, Gd or La; Rε is Eu²⁺, Ce³⁺, Yb²⁺, Sm³⁺, Pr³⁺ or a mixture thereof, Rε is present in an amount to provide luminescent emission, and f, a, b, c, d, and g are selected to provide a charge neutral solid solution or compound. In some embodiments, M and N+O are necessarily present in a stoichiometric amount. One or more of Si, Al, B and O may not be present. The phosphors optionally have a component of halide or mixture of halides Z¹ (selected from Cl⁻, F⁻, Br⁻ or I⁻)/

In certain embodiments, the mole percentage of Re is 0.001% to 10%. In certain embodiments, the range of the mole percentage of Re is from one of the following lower endpoints (inclusive) or from one of the following upper endpoints (inclusive). 0.001%, 0.01%, 0.02%, 0.05%, 0.1%, 0.2%, 0.5%, 1%, 2%, 3%, 4% and 5%. The upper endpoints are 0.01%, 0.02%, 0.05%, 0.1%, 0.2%, 0.5%, 1%, 2%, 3%, 4%, 5% and 10%. For example, the range can be 0.01% to 5%.

In certain embodiments, the range of the mole percentage of Z¹, is from one of the following lower endpoints (inclusive) or from one of the following upper endpoints (inclusive). The lower endpoints are 0.1%, 0.2%, 0.5%, 1%, 2%, 3%, 4% and so on in increments of 1% up to 19%. The upper endpoints are 0.2%, 0.5%, 1%, 2%, 3%, 4%, 5% and so on in increments of 1% up to 20%. For example, the range can be 1% to 10%, or from 2% to 7%.

Group B

In one embodiment, the phosphors of the invention are metal silicon nitride or nitride-oxide doped with Re and having a minor component Z. These are according to the formula:
Msn:Rγ,Z² (B)
wherein Rγ is Eu²⁺, Ce³⁺, Yb²⁺, Sm³⁺, Pr³⁺, or a mixture thereof, Rγ is present in an amount to provide luminescent emission, Z² is a halide or mixture of halides (selected from Cl⁻, F⁻, Br⁻ or I⁺), Z² is present in an amount from 0.1 mole % to 20 mole % (of Msn), and Msn is a silicon nitride or silicon nitride-oxide of one of:
(Mₓ¹M₁₋ₓ² )(Si₅N₈):Rγ,Z² (i)
Lsno:Rγ,Z² (ii)
Ln₂Si_{3-z}Al_{z}O_{3+z}N_{4-z}:Rγ,Z² (iii)
wherein M¹ and M² are independently selected from Mg²⁺, Ca²⁺, Sr²⁺and Ba²⁺, x is a value from 0.5 to 1, z is a value from 0 to 2. Lsno is a lanthanide silicon nitride-oxide of one of:
Ln(SiO₄)N₃:Rγ,Z² (iia)
LnSi₂O₇N₂:Rγ,Z² (iib)
LnSiO₂N:Rγ,Z² (iic)
Ln₂SiO₃N₄:Rγ,Z² (iid)
Ln₂Si₈O₄N₁₁:Rγ,Z² (iie)
wherein Ln is a trivalent lanthanide or mixture of trivalent lanthanides. In certain embodiments, x is 0.5 to 0.9999. In certain embodiments, the halide(s) are fluorine, chlorine, bromine, iodine or mixtures thereof.

The primary formulas (before the colon) listed for formulas (i), (iia), (iib), (iic), (iid), (iie), and (iii) are the empirical formulas calculated as if no substitution with Re and no being subject to the process to add halide. Those of skill will recognize the modifications resulting from addition of Re, and the halide addition process.

In certain embodiments, the mole percentage of Rγ is 0.001% to 10%. In certain embodiments, the range of the mole percentage of Rγ is from one of the following lower endpoints (inclusive) or from one of the following upper endpoints (inclusive). 0.001%, 0.01%, 0.02%,0.05%,0.1%,0.2%,0.5%,1%, 2%,3%,4% and 5%. The upper endpoints are 0.01%, 0.02%,0.05%,0.1%,0.2%,0.5%,1%, 2%,3%, 4%, 5% and 10%. For example, the range can be 0.01% to 5%.

In certain embodiments, the range of x is from one of the following lower endpoints (inclusive) or from one of the following upper endpoints (inclusive). The lower endpoints are 0.5, 0.55, 0.6, 0.65, 0.7, 0.75, 0.8, 0.85, 0.9 and 0.95. The upper endpoints are 0.55, 0.6, 0.65, 0.7, 0.75, 0.8, 0.85, 0.9, 0.95, 0.96, 0.97, 0.98, 0.99, 0.999, 0.9999 and 1.0.

In certain embodiments, the range of z is from one of the following lower endpoints (inclusive) or from one of the following upper endpoints (inclusive). The lower endpoints are 0, 0.01, 0.05, 0.1, 0.2, 0.3, 0.4, 0.5, 0.55, 0.6, 0.65, 0.7, 0.75, 0.8, 0.85, 0.9, 1.0, 1.2 and 1.5. The upper endpoints are 0.01, 0.05, 0.1, 0.2, 0.3, 0.4, 0.5, 0.55, 0.6, 0.65, 0.7, 0.75, 0.8, 0.85, 0.9, 1.0, 1.2, 1.5 and 2.0.

In certain embodiments, the range of the mole percentage of Z², is from one of the following lower endpoints (inclusive) or from one of the following upper endpoints (inclusive). The lower endpoints are 0.1%, 0.2%,0.5%, 1%, 2%,3%,4% and so on in increments of 1% up to 19%. The upper endpoints are 0.2%, 0.5%,1%,2%, 3%,4%, 5% and so on in increments of 1% up to 20%. For example, the range can be 1% to 10%, or from 2% to 7%.

Group C

In one embodiment, the phosphors of the invention are metal silicon boronitride doped with Rδ, and optionally having a component of halide or mixture of halides Z³ (selected from Cl⁻, F⁻, Br⁻ or I⁻). These are according to the formula:
Mₙ³Si_{3-y}BO_{3+y}N_{4-y}:Rδ,Z³ (C)
wherein Rδ is Eu²⁺, Sm²⁺, Yb²⁺, Ce³⁺, Pr³⁺, or a mixture thereof, Re is present in an amount to provide luminescent emission, Y is a halide or mixture of halides, Z³ is present in an amount from 0 to 40 mole %, or 1 mole % to 40 mole %, M³ is (i) a trivalent lanthanide which is La, Ce, Pr, Nd, Sm, Eu, Gd, Tb, Dy, Ho, Er, Tm, Yb, or a mixture thereof or (ii) a divalent alkaline earth cation or mixture thereof, and n is the summed formula contributions of the metal(s) of M³, with the value appropriate in light of the valence of the component cations to balance formula (I), and y is a value from 0 to 1. The M³ₙSi_{3-y}BO_{3+y}N_{4-y} portion of formula (I) is calculated as if Z³ would not substitute for anionic components of that portion, though of course it will, typically substituting for part of the oxygen component. The negative valence balanced by the cations of M³ is 2.

The primary formulas (before the colon) listed for formula (I) is the empirical formula calculated as if no substitution with Rδ and no being subject to the process to add halide. Those of skill will recognize the modifications resulting from addition of Rδ, and the halide addition process.

In certain embodiments, the mole percentage of Rδ is 0.001% to 10%. In certain embodiments, the range of the mole percentage of Rδ is from one of the following lower endpoints (inclusive) or from one of the following upper endpoints (inclusive). 0.001%, 0.01%, 0.02%, 0.05%, 0.1%, 0.2%, 0.5%, 1%, 2%, 3%, 4% and 5%. The upper endpoints are 0.01%, 0.02%, 0.05%, 0.1%, 0.2%, 0.5%, 1%, 2%, 3%, 4%, 5% and 10%. For example, the range can be 0.01% to 5%.

In certain embodiments, the range of y is from one of the following lower endpoints (inclusive) or from one of the following upper endpoints (inclusive). The lower endpoints are 0, 0.0001, 0.001, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9 and 0.95. The upper endpoints are 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 0.96, 0.97, 0.98, 0.99, 0.999, 0.9999 and 1.0.

In certain embodiments, the range of the mole percentage of Z³, is from one of the following lower endpoints (inclusive) or from one of the following upper endpoints (inclusive). The lower endpoints are 1%, 2%, 3%, 4%, 5%, and so on in increments of 1% until 39%. The upper endpoints are 2%, 3%, 4%, 5%, and so on in increments of 1% until 40%. For example, the range can be 1% to 20%, or 5% to 20%.

Group D

In one embodiment, the phosphors of the invention are metal silicon boronitride doped with Rφ, and optionally having a component of halide or mixture of halides Z⁴ (selected from Cl⁻, F⁻, Br⁻ or I⁻). These are according to the formula:
Mn_{f1}⁴Siₐ₁Al_{b1}B_{c1}N_{d1-e1-g1}O_{g1}Dₑ₁:Rφ, Z⁴ (D)
wherein M⁴ is one or more of (i) the following divalent cations: Ba, Sr, Ca, Zn, Mg and (ii) 1:1 mixtures of (1) monovalent Li, Na or K and (2) trivalent Y, Gd or La; Rφ is Eu²⁺, Ce³⁺, Yb²⁺, or ions of Pr, Nd, Sm, Gd, Tb, Dy, Ho, Er or Tm, or a mixture of the foregoing choices for Rφ, Rφ is present in an amount to provide luminescent emission, D is P, Bi, Sb, As or a mixture thereof, in atomic or ionic form, and f1, a1, b1, c1, d1 and e1 are selected to provide a charge neutral solid solution or compound. In one embodiment, M and N+O+D are necessarily present in a stoichiometric amount. One or more of Al and B may not be present.

In certain embodiments, the range of the mole percentage of Z⁴, is from one of the following lower endpoints (inclusive) or from one of the following upper endpoints (inclusive). The lower endpoints are 0.01%, 0.02%, 0.03%, 0.04%, 0.05%, 0.06%, and 0.08%. The upper endpoints are 0.02%, 0.03%, 0.04%, 0.05%, 0.06%, 0.07%, 0.08%, 0.09%, and 0.1%.

In one embodiment, D comprises 0.01 mole percent or more of P (phosphorus). In one embodiment, D comprises a substantial percentage of P, for example 0.1 mole percent or more of P. In one embodiment, P comprises 0.01 mole percent or more, or 0.1 mole percent or more, of N+O+D.

To make one embodiment of D:Ca—Si—Al—N—P:Eu
(1) Mix calcium carbonate, europium metal, silicon nitride, aluminum nitride in dry powder form. This step ensures the intimate contact of the reactant ingredients ready for the solid state chemical reactions.
(2) Mill the mixture to achieve further contact at a fine particle level of the inorganic solids.
(3) Firing under ammonia atmosphere at 1200-1700° C.
(4) Mix the product of the above firing step with red phosphorus.
(5) Fire the mixture of step (4) in nitrogen gas or argon gas at 900° C.
(6) Grind and sieve the product.

To make one embodiment of D:Ca—Si—Al—N—P:Eu
(1) Mix calcium nitride, europium metal, silicon nitride, aluminum nitride and calcium phosphide in dry powder form. This step ensures the intimate contact of the reactant ingredients ready for the solid state chemical reactions.
(2) Mill the mixture to achieve further contact at a fine particle level of the inorganic solids.
(3) Firing under ammonia atmosphere at 1200-1700° C.
(4) Grind and sieve the product.

The disclosed phosphor products will enable the LED white lamp makers to deliver high CRI (>84), high efficient (>90%) and long lifetime (>100,000 hr) lighting products, which are unachievable with the existing phosphor products.

### BRIEF DESCRIPTION OF THE DRAWINGS

FIG. 1 shows a phosphor phase diagram.

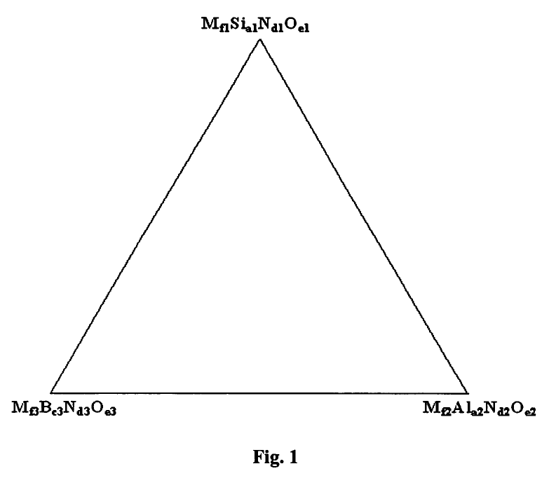

FIGS. 2 and 3 show light emitting devices.

FIGS. 4 and 5 show X-ray diffraction patterns for phosphors of the invention.

FIG. 6 illustrates an exemplary layer structure for a near UV emitting semiconductor light source.

### DETAILED DESCRIPTION OF THE INVENTION

The nitride phosphors are believed to fall into a class of nitride ceramic material known to possess high chemical stability, due to the chemical bond between silicon and nitrogen (and/or between Al and N, and/or between B and N). In a typical coordination form, a silicon atom (or aluminum or boron) is coordinated with four or six nitrogen atoms. These basic coordination units form either edge sharing or point sharing continual networks in three-dimensional space. Since the central ion, Si, has a valence of +4 and the N ions possess valence of −3, the coordinated units generally are electronegative elements that can accommodate electropositive element such as alkaline earth metal ions. Studies on nitridosilicates shows that the bonds between the SiN units and the metal-nitrogen bonds are highly covalent with very high bond energy. This fact demonstrates that the materials are highly stable in normal conditions and inert to water and oxygen. These features are believed to apply to many of the corresponding forms with Al or B or mixtures of two or more of Al, B and Si.

In certain embodiments, the absorption peak wavelength is adjusted to the 450-470 nm region by appropriate selection of the metal(s) of M, M¹, M², M³.

Synthesis can, for example, include: (1) mixing appropriate precursors (e.g., the metal carbonates, boron nitride and europium) in a slurry (this step ensures the intimate contact of the reactant ingredients ready for the solid-state chemical reactions); (2) milling the mixture to achieve further contact at a fine particle level of the inorganic solids; (3) firing under nitriding atmosphere at 1200-1700° C. to form the phosphor materials; and (4) post formation treatment such as sieving or size separation.

To make the phosphors of Group B, for example, one can mix an appropriate combination (less halide source) of the raw materials (in view of the targeted material according to Formula I), for example in a alcoholic slurry by ball milling, for example for 5 hours. The mixed raw materials are then dried (e.g., oven dried) and ground. The dried powder is then fired (for example in graphite crucibles) at, for example, 1200-1500° C., under reducing gas (for example, H2/N2 forming gas) atmosphere. The fired phosphor is mixed with an appropriate amount of metal halide and fired in a closed vessel (e.g., capped graphite crucible) as appropriate to make the substitutions required by Formula I (e.g., 1400° C. for 3 hours). Exemplary materials can include, for example, Eu₂(O₂CCO₂)₃ (europium oxalate, for example with purity 99.99%), MgCO₃, CaCO₃, BaCO₃ SrCO₃ (for example, all with purity >99.9%), Si₃N₄, SiO₂ (for example, aerosil 300, Degussa) and BN (for example, purity>99.9%). As the halide source, a portion of the salt providing metal can be, for example, substituted with a metal-providing halide (e.g., SrF₂, SrCl₂, CaF₂ or CaCl₂).

To make the phosphors of Group C, for example, one can mix an appropriate combination of the raw materials (in view of the targeted material according to Formula (IB)), for example in a alcoholic slurry by ball milling, for example for 5 hours. The mixed raw materials are then dried (e.g., oven dried) and ground. The dried powder is then fired (for example in graphite crucibles) at, for example, 1300-1500° C., under reducing gas (for example, H2/N2 forming gas) atmosphere. Where halide is added, the fired phosphor is mixed with an appropriate amount of metal halide and fired in a closed vessel (e.g., capped graphite crucible) as appropriate to make the substitutions required by Formula I (e.g., 1400° C. for 3 hours). Exemplary materials can include, for example, Eu₂(O₂CCO₂)₃ (europium oxalate, for example with purity 99.99%), MgCO₃, CaCO₃, BaCO₃ SrCO₃ (for example, all with purity >99.9%), Si₃N₄, SiO₂ (for example, aerosil 300, Degussa) and BN (for example, purity>99.9%). As the halide source, a portion of the salt providing metal can be, for example, substituted with a metal-providing halide (e.g., SrF₂).

The emission peak is measured with the emission source being light at 440 nm±100 nm. In certain embodiments, the range is from one of the following lower endpoints (inclusive) or from one of the following upper endpoints (inclusive). The lower endpoints are 380, 381, 382, 383, and each one nm increment up to 799 nm. The upper endpoints are 800, 799, 798, 797, and each one nm down to 381. In some embodiments, the lower endpoints are 520, 521, 522, and each one nm increment up to 649 nm. In some embodiments, the upper endpoints are 650, 649, 648, and each one nm increment down to 521 nm.

The excitation peak range is from one of the following lower endpoints (inclusive) or from one of the following upper endpoints (inclusive). The lower endpoints are 360, 361, 362, 363, and each one nm increment up to 520 nm. The upper endpoints are 520, 519, 518, 517, and each one nm down to 361.

When used in a lighting device, it will be recognized that the phosphors can be excited by light from a primary source, such as an semiconductor light source emitting in the wavelength of 300˜420 nm, or from secondary light such as emissions from other phosphor(s) emitting in the same wavelength range. Where the excitation light is secondary, in relation to the phosphors of the invention, the excitation-induced light is the relevant source light. Devices that use the phosphor of the invention can include mirrors, such as dielectric mirrors, to direct light produced by the phosphors to the light output rather than the interior of the device (such as the primary light source).

The semiconductor light source can, in certain embodiments, emit light of 300 nm or more, or 305 nm or more, or 310 nm or more, and so on in increments of 5 nm to 400 nm or more. The semiconductor light source can, in certain embodiments, emit light of 420 nm or less, or 415 nm or less, or 410 nm or less, and so on in increments of 5 nm to 350 nm or less.

Phosphor particles may be dispersed in the lighting device with a binder or solidifier, dispersant (i.e., light scattering material), filler or the like, The binder can be, for example, a light curable polymer such as an acrylic resin, an epoxy resin, polycarbonate resin, a silicone resin, glass, quartz and the like. The phosphor can be dispersed in the binder by methods known in the art. For example, in some cases the phosphor can be suspended in a solvent, and the polymer suspended, dissolved or partially dissolved in the solvent, the slurry dispersed on the lighting device, and the solvent evaporated. In some cases, the phosphor can be suspended in a liquid, pre-cured precursor to the resin, the slurry dispersed, and the polymer cured. Curing can be, for exanple, by heat, UV, or a curing agent (such as a free radical initiator) mixed in the precursor. Or, in another example, the binder may be liquefied with heat, a slurry formed, and the slurry dispersed and allowed to solidify in situ. Dispersants include, for example, titanium oxide, aluminum oxide, barium titanate, silicon dioxide, and the like.

It is anticipated that lighting devices of the invention will use semiconductor light sources such as LEDs to either create excitation energy, or excite another system to provide the excitation energy for the phosphors. Devices using the invention can include, for example, white light producing lighting devices, indigo light producing lighting devices, blue light producing lighting devices, green light producing lighting devices, yellow light producing lighting devices, orange light producing lighting devices, pink light producing lighting devices, red light producing lighting devices, or lighting devices with an output chromaticity defined by the line between the chromaticity of a phosphor of the invention and that of one or more second light sources. Headlights or other navigation lights for vehicles can be made with the devices of the invention. The devices can be output indicators for small electronic devices such as cell phones and PDAs. The lighting devices can also be the backlights of the liquid crystal displays for cell phones, PDAs and laptop computers. Given appropriate power supplies, room lighting can be based on devices of the invention. The warmth (i.e., amount of yellow/red chromaticity) of lighting devices can be tuned by selection of the ratio of light from phosphor of the invention to light from a second source.

Suitable semiconductor light sources are any that create light that excites the phosphors, or that excites a phosphor that in turn excites the phosphors of the invention. Such semiconductor light sources can be, for example, Ga—N type semiconductor light sources, In—Al—Ga—N type semiconductor light sources, and the like. In some embodiments, blue or near UV emitting semiconductor light sources are used.

For a semiconductor light source having a using at least two different phosphors, it can be useful to disperse the phosphors separately, and superimpose the phosphor layers instead of dispersing the phosphors together in one matrix. Such layering can be used to obtain a final light emission color by way of a plurality of color conversion processes. For example, the light emission process is: absorption of the semiconductor light source light emission by a first phosphor, light emission by the first phosphor, absorption of the light emission of the first phosphor by a second phosphor, and the light emission by the second phosphor.

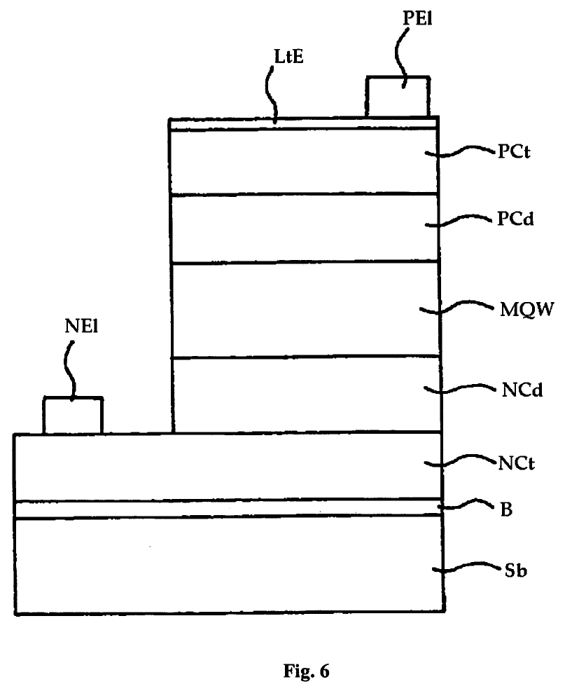

FIG. 6 shows an exemplary layer structure of a semiconductor light source. The blue semiconductor light comprises a substrate Sb, for example, a sapphire substrate. For example, a buffer layer B, an n-type contact layer NCt, an n-type cladding layer NCd, a multi-quantum well active layer MQW, a p-type cladding layer PCd, and a p-type contact layer PCt are formed in that order as nitride semiconductor layers. The layers can be formed, for example, by organometallic chemical vapor deposition (MOCVD), on the substrate Sb. Thereafter, a light-transparent electrode LtE is formed on the whole surface of the p-type contact layer PCt, a p electrode PEl is formed on a part of the light-transparent electrode LtE, and an n electrode NEl is formed on a part of the n-type contact layer NCt. These layers can be formed, for example, by sputtering or vacuum deposition.

The buffer layer B can be formed of, for example, AlN, and the n-type contact layer NCt can be formed of, for example, GaN.

The n-type cladding layer NCd can be formed, for example, of AlᵣGa₁₋ᵣN wherein 0≦r<1, the p-type cladding layer PCd can be formed, for example, of Al_{q}Ga_{1-q}N wherein 0<q<1, and the p-type contact layer PCt can be formed, for example, of AlₛGa₁₋ₛN wherein 0≦s<1 and s<q. The band gap of the p-type cladding layer PCd is made larger than the band gap of the n-type cladding layer NCd. The n-type cladding layer NCd and the p-type cladding layer PCd each can have a single-composition construction, or can have a construction such that the above-described nitride semiconductor layers having a thickness of not more than 100 angstroms and different from each other in composition are stacked on top of each other so as to provide a superlattice structure. When the layer thickness is not more than 100 angstroms, the occurrence of cracks or crystal defects in the layer can be prevented.

The multi-quantum well active layer MQW can be composed of a plurality of InGaN well layers and a plurality of GaN barrier layers. The well layer and the barrier layer can have a thickness of not more than 100 angstroms, preferably 60 to 70 angstroms, so as to constitute a superlattice structure. Since the crystal of InGaN is softer than other aluminum-containing nitride semiconductors, such as AlGaN, the use of InGaN in the layer constituting the active layer MQW can offer an advantage that all the stacked nitride semiconductor layers are less likely to crack. The multi-quantum well active layer MQW can also be composed of a plurality of InGaN well layers and a plurality of AlGaN barrier layers. Or, the multi-quantum well active layer MQW can be composed of a plurality of AlInGaN well layers and a plurality of AlInGaN barrier layers. In this case, the band gap energy of the barrier layer can be made larger than the band gap energy of the well layer.

A reflecting layer can be provided on the substrate Sb side from the multi-quantum well active layer MQW, for example, on the buffer layer B side of the n-type contact layer NCt. The reflecting layer can also be provided on the surface of the substrate Sb remote from the multi-quantum well active layer MQW stacked on the substrate Sb. The reflecting layer can have a maximum reflectance with respect to light emitted from the active layer MQW and can be formed of, for example, aluminum, or can have a multi-layer structure of thin GaN layers. The provision of the reflecting layer permits light emitted from the active layer MQW to be reflected from the reflecting layer, can reduce the internal absorption of light emitted from the active layer MQW, can increase the quantity of light output toward above, and can reduce the incidence of light on the mount for the light source to prevent a deterioration.

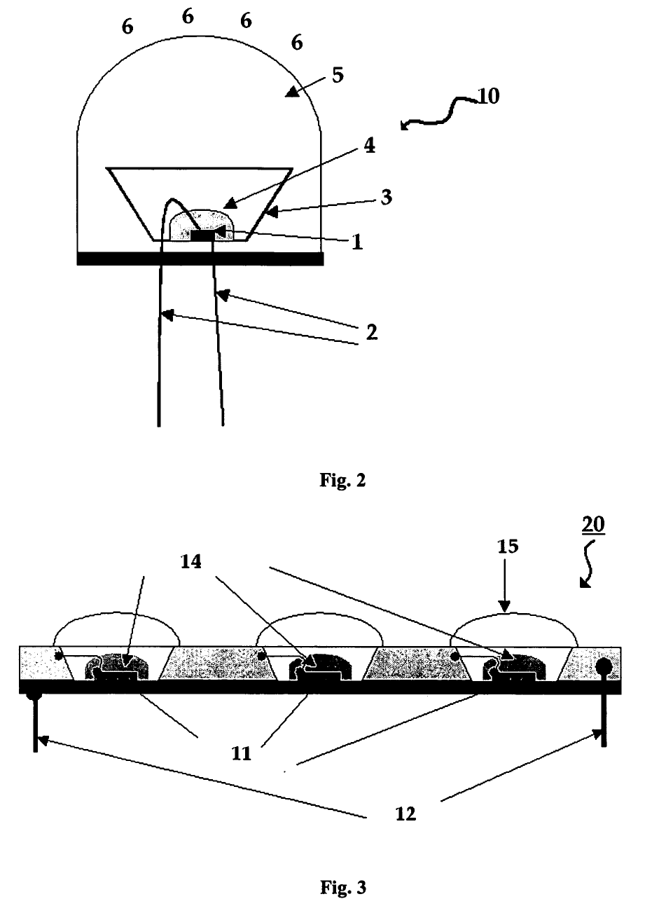

Shown in FIGS. 2-3 are some exemplary LED-phosphor structures. FIG. 2 shows a light emitting device 10 with an LED chip 1 powered by leads 2, and having phosphor-containing material 4 secured between the LED chip and the light output 6. A reflector 4 can serve to concentrate light output. A transparent envelope 5 can isolate the LED and phosphor from the environment and/or provide a lens. The lighting device 20 of FIG. 3 has multiple LED chips 11, leads 12, subsidiary leads 12′, phosphor-containing material 14, and transparent envelope 15.

It will be understood by those of ordinary skill in the art that there are any number of ways to associate phosphors with an semiconductor light source such that light from the semiconductor light source is managed by its interaction with the phosphors. U.S. patent applications 2004/0145289 and 2004/0145288 illustrate lighting devices where phosphor is positioned away from the light output of the semiconductor light sources. U.S. patent applications 2004/01450307 and 2004/0159846 further illustrate, without limitation, lighting devices that can be used in the invention.

Semiconductor light source-based white light devices can be used, for example, in a self-emission type display for displaying a predetermined pattern or graphic design on a display portion of an audio system, a household appliance, a measuring instrument, a medical appliance, and the like. Such semiconductor light source-based light devices can also be used, for example, as light sources of a back-light for LCD displays, a printer head, a facsimile, a copying apparatus, and the like.

Among the additional phosphors that can be mixed with phosphors of the invention, some of those believed to be useful include: Y₃Al₅O₁₂:Ce³⁺(YAG), Lu₃Ga₂(AlO₄)₃:Ce³⁺; La₃In₂(AlO₄)₃:Ce³⁺; Ca₃Ga₅O₁₂:Tb³⁺; BaYSiAlO₁₂:Ce³⁺; CaGa₂S₄:Eu²⁺; SrCaSiO₄:Eu²⁺; ZnS:Cu, CaSi₂O₂N:Eu²⁺; SrSi₂O₂N:Eu²⁺; SrSiAl₂O₃N₂:Eu²⁺; Ba₂MgSi₂O₇:Eu²⁺; Ba₂SiO₄:Eu²⁺; La₂O₃.11Al₂O₃:Mn²⁺; Ca₈Mg(SiO₄)₄Cl₄:Eu²⁺,Mn²⁺; (CaM)(Si,Al)₁₂(O,N)₁₆:Eu²⁺,Tb³⁺,Yb³⁺; YBO₃:Ce³⁺,Tb³⁺; BaMgAl₁₀O₁₇:Eu²⁺, Mn²⁺; (Sr,Ca,Ba)(Al,Ga)₂S₄:Eu²⁺; BaCaSi₇N₁₀:Eu²⁺; (SrBa)₃MgSi₂O₈:Eu²⁺; (SrBa)₂O₇:Eu²⁺; (SrBa)₂Al₁₄O₂₅:Eu²⁺; LaSi₃N₅:Ce³⁺; (BaSr)MgAl₁₀O₁₇:Eu²⁺; and CaMgSi₂O₇:Eu²⁺.

Temperatures described herein for processes involving a substantial gas phase are of the oven or other reaction vessel in question, not of the reactants per se.

“White” light is light that of certain chromaticity values (known and well published in the art).

The following examples further illustrate the present invention, but of course, should not be construed as in any way limiting its scope.

### EXAMPLE 1

### Preparation of (Ba_{0.5}Sr_{0.5})(Si₅N₈):Eu,F

The materials tabulated below (in gram amounts), excepting the halide, are mixed in EtOH by ball milling:

| BaCO₃ | SrCO₃ | Si₃N₄ | Eu₂(Ox)₃ | SrF₂ |
|---|---|---|---|---|
| 0.895 | 0.443 | 70.2 | 0.112 | 0.251 |

(Ox stands for oxalate.) The mixed raw materials are then oven dried and ground in a mortar. The dried powder is then fired in a graphite crucible at 1400° C., under forming (H2/N2) gas atmosphere. The halide is then mixed with the fired product, and re-fired in a capped graphite crucible at 1400° C.

### EXAMPLE 2

### Preparation of Y₂Si₂AlO₄N₃:Eu,F

The materials tabulated below (in gram amounts), excepting the halide, are mixed in EtOH by ball milling:

| Y₂O₃ | Al₂O₃ | Si₃N₄ | Eu₂(Ox)₃ | SiO₂ | YF₃ |
|---|---|---|---|---|---|
| 3.389 | 1.691 | 0.205 | 0.321 | 0.082 | 0.451 |

The mixed raw materials are then oven dried and ground in a mortar. The dried powder is then fired in a graphite crucible at 1400° C., under forming (H2/N2) gas atmosphere. The halide is then mixed with the fired product, and re-fired in a capped graphite crucible at 1400° C.

### EXAMPLE 3

The materials tabulated below (in gram amounts) are mixed in EtOH by ball milling:

| Eu₂(Ox)₃ | SrCO₃ | Si₃N₄ | SiO₂ | BN | SrF₂ |
|---|---|---|---|---|---|
| 0.112 | 1.47 | 0.702 | 0.3 | 0.25 | 0.142 |

(Ox stands for oxalate.) The mixed raw materials are then oven dried and ground in a mortar. The dried powder is then fired in graphite crucibles at 1400° C., under forming (H2/N2) gas atmosphere.

### EXAMPLE 4

### Preparation of Y—Mg—SiBON:Eu

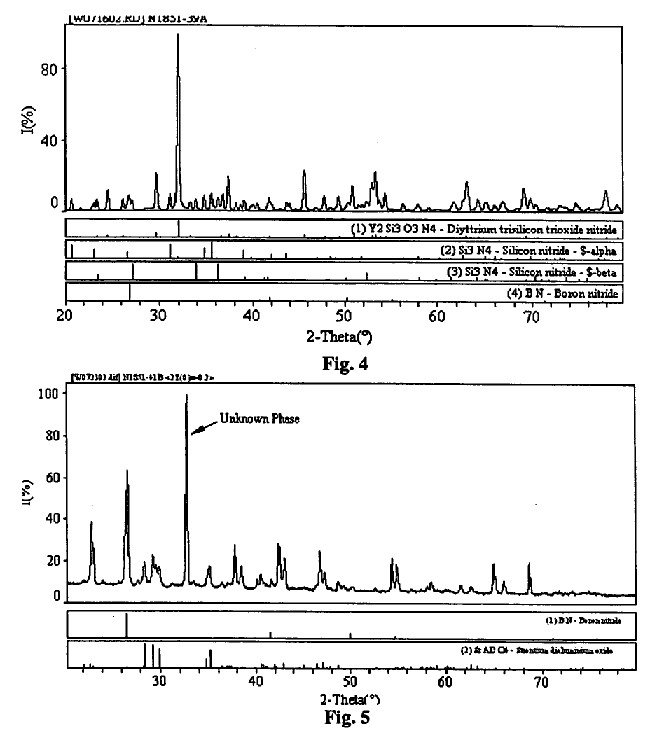

Powders of the following materials were mixed
MgCO3, 4.2867 g
Y2O3, 5.421 g
Si3N4, 9.353 g
BN, 1.241 g.
   The mixture was fired at 1400° C. under 5% H₂ in N₂ for 5 hours. A pale green powder product was obtained. An X-ray diffraction pattern of the product is shown in FIG. 4.

### EXAMPLE 5

### Preparation of Sr—Al—B—N:Eu

Powders of the following materials were mixed
SrCO3, 11.8096 g
BN, 2.9784 g
AlN, 3.278 g
   The mixture was fired at 1400° C. under 5% H₂ in N₂ for 1 hour. After cooling to room temperature, the powder was milled. The milled powder was fired at 1400° C. under 5% H₂ in N₂ for 2 hours. A pale green powder product was obtained. An X-ray diffraction pattern of the product is shown in FIG. 5.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

1. A phosphor according to one of A, B, C or D, below:
A. a phosphor according to the following formula
M_{f}SiₐAl_{b}B_{c}N_{d}O_{g}:Rε,Z (A)
wherein M is one or more of (i) the following divalent cations: Ba, Sr, Ca, Zn, Mg and (ii) 1:1 mixtures of (1) monovalent Li, Na or K and (2) trivalent Y, Gd or La; Rε is Eu²⁺, Ce³⁺, Yb²⁺, Sm³⁺, Pr³⁺, or a mixture thereof; Rε is present in an amount to provide luminescent emission; f, a, b, c, d, and g are selected to provide a charge neutral solid solution or compound; f, a, b, and g are ≧0; c and d are >0; and Z is an optional halide or halides selected from Cl⁻, F⁻, Br⁻ or I⁻; or
B. a phosphor according to the following formula
Msn:Rγ,Z² (B)
wherein Rγ is Eu²⁺, Ce³⁺, Yb²⁺, Sm³⁺, Pr³⁺, or a mixture thereof, Rγ is present in an amount to provide luminescent emission, Z² is a halide or mixture of halides selected from Cl⁻, F⁻, Br⁻ or I⁻, Z² is present in an amount from 0.1 mole % to 20 mole % (of Msn), and Msn is a silicon nitride or silicon nitride-oxide of one of:
(Mₓ¹M₁₋ₓ²)(Si₅N₈):Rγ,Z² (i)
Lsno:Rγ,Z² (ii)
Ln₂Si_{3-z}Al_{z}O_{3+z}N_{4-z}:Rγ,Z² (iii)
wherein M¹ and M² are independently selected from Mg²⁺, Ca²⁺, Sr²⁺ and Ba²⁺, x is a value from 0.5 to 1, z is a value from 0 to 2, Lsno is a lanthanide silicon nitride-oxide of one of:
Ln(SiO₄)N₃:Rγ,Z² (iia)
LnSi₂O₇N₂:Rγ,Z² (iib)
LnSiO₂N:Rγ,Z² (iic)
Ln₂SiO₃N₄:Rγ,Z² (iid)
Ln₂Si₈O₄N₁₁:Rγ,Z² (iie)
wherein Ln is a trivalent lanthanide or mixture of trivalent lanthanides; or
C. a phosphor according to the following formula
Mₙ³Si_{3-y}BO3+yN_{4-y}:Rδ,Z (C)
wherein Rδ is Eu²⁺, Sm²⁺, Yb²⁺, Ce³⁺, Pr³⁺, or a mixture thereof, Rδ is present in an amount to provide luminescent emission, Z³ is a halide or mixture of halides selected from Cl⁻, F⁻, Br⁻ or I⁻, Z³ is present in an amount from 0 to 40 mole %, M³ is (i) a trivalent lanthanide which is La, Ce, Pr, Nd, Sm, Eu, Gd, Tb, Dy, Ho, Er, Tm, Yb, or a mixture thereof or (ii) a divalent alkaline earth cation or mixture thereof, and n is the summed formula contributions of the metal(s) of M³, with the value appropriate in light of the valence of the component cations to balance formula (I), and y is a value from 0 to 1; or
D. a phosphor according to the following formula
M_{f1}⁴Siₐ₁Al_{b1}B_{c1}N_{d1-e1-g1}O_{g1}Dₑ₁:Rφ,Z⁴ (D)
wherein M⁴ is one or more of (i) the following divalent cations: Ba, Sr, Ca, Zn, Mg and (ii) 1:1 mixtures of (1) monovalent Li, Na or K and (2) trivalent Y, Gd or La; Rφ is Eu²⁺, Ce³⁺, Yb²⁺, or ions of Pr, Nd, Sm, Gd, Tb, Dy, Ho, Er or Tm, or a mixture of the foregoing choices for Rφ; Rφ is present in an amount to provide luminescent emission; D is P, Bi, Sb, As or a mixture thereof, in atomic or ionic form; f1, a1, b1, c1, d1, e1 and g1 are selected to provide a charge neutral solid solution or compound; a1 and b1 are ≧0; f1, c1, d1, e1 and g1 are >0; and Z⁴ is a halide or mixture of halides selected from Cl⁻, F⁻, Br⁻ or I⁻, which is optionally present.

2. A phosphor according to claim 1, wherein the phosphor is according to formula A, C or D and comprises, respectively, Z, Z³ and Z⁴.

3. A phosphor according to claim 1, wherein the phosphor is according to formula D and wherein D comprises P.

4. A phosphor according to claim 1, wherein the phosphor is according to formula D and wherein D comprises 0.01% mole percent or more of N+O+D.

5. A phosphor according to claim 1, wherein the phosphor is according to formula D and wherein P comprises 0.01% mole percent or more of N+O+D.

6. A light emitting device comprising:
a semiconductor light source producing light output including wavelengths of 300 nm or more; and
a wavelength manager located between the light source and the light output for the device, comprising a phosphor according to claim 1.

7. The light emitting device of claim 6, wherein the wavelength manager comprises one or more additional phosphors, the one or more additional phosphors adjusting light produced by the device.

8. The light emitting device of claim 7, wherein the wavelength manager changes the light output to white light.

9. A light emitting device according to claim 6, wherein:
the semiconductor light source comprises a double hetero structure comprising a light emitting layer sandwiched between a p-type clad layer and an n-type clad layer.

10. A light emitting device according to claim 9, wherein:
the p-type clad layer is formed of Al_{q}Ga_{1-q}N where 0<q<1, and the n-type clad layer is formed of AlᵣGa₁₋ᵣN where 0≦r<1; and/or
the band gap of the p-type clad layer is larger than that of the n-type clad layer.

11. A light emitting device according to claim 6, wherein:
the semiconductor light source comprises a light emitting layer containing indium and comprising a quantum well structure.

12. A light emitting device according to claim 11, wherein:
the quantum well structure comprises a well layer of InGaN and a barrier layer of GaN; and/or
the quantum well structure comprises a well layer of InGaN and a barrier layer of AlGaN; and/or
the quantum well structure comprises a well layer of AlInGaN and a barrier layer of AlInGaN, and the band gap energy of the barrier layer is larger than that of the well layer; and/or
wherein: the well layer has a thickness of not more than 100 angstroms.
